(19) United States
(12) Patent Application Publication
(10) Pub. No.: US 2016/0009886 A1
(43) Pub. Date: Jan. 14, 2016

(54) METHODS OF MANUFACTURING EXTRUDED POLYSTYRENE FOAMS USING CARBON DIOXIDE AS A MAJOR BLOWING AGENT

(71) Applicant: Owens Corning Intellectual Capital, LLC, Toledo, OH (US)

(72) Inventors: Xiangmin Han, Stow, OH (US); Yadollah Delaviz, Lewis Center, OH (US); Chase J. Boudreaux, Canton, OH (US); Mitchell Zane Weekley, Tallmadge, OH (US)

(21) Appl. No.: 14/795,037

(22) Filed: Jul. 9, 2015

Related U.S. Application Data
(60) Provisional application No. 62/022,759, filed on Jul. 10, 2014.

(51) Int. Cl. C08J 9/14; C08J 9/12; C08J 9/00

(52) U.S. Cl. CPC C08J 9/146; C08J 9/0071; C08J 9/122; C08J 2325/06

(57) ABSTRACT

A composition and method for making extruded polystyrene (XPS) foam is provided. The composition includes carbon dioxide as a major blowing agent to achieve an XPS foam having an improved thermal insulation performance.

### RELATED APPLICATIONS

This application claims the benefit of U.S. provisional application No. 62/022,759 filed on Jul. 10, 2014, titled “Methods of Manufacturing Extruded Polystyrene foams Using Carbon Dioxide as a Major Blowing Agent” which is incorporated herein by reference in its entirety.

### FIELD OF THE DISCLOSURE

The present disclosure relates to a composition and method for making extruded polystyrene (XPS) foam. Particularly, the present disclosure relates to a blowing agent composition comprising a majority of carbon dioxide, in terms of molar percentage, to achieve XPS foam having an improved thermal insulation performance.

### BACKGROUND

The general procedure utilized in the preparation of extruded synthetic foam includes the steps of first melting a base polymeric composition, and thereafter incorporating one or more blowing agents and other additives into the polymeric melt under conditions that provide for the thorough mixing of the blowing agent and the polymer while preventing the mixture from foaming prematurely, e.g., under pressure. This mixture is then typically extruded through a single or multi-stage extrusion die to cool and reduce the pressure on the mixture, allowing the mixture to foam and produce a foamed product. As will be appreciated, the relative quantities of the polymer(s), blowing agent(s) and additives, the temperature, and the manner in which the pressure is reduced will tend to affect the qualities and properties of the resulting foam product. As will also be appreciated, the foamable mixture is maintained under a relatively high pressure until it passes through an extrusion die and is allowed to expand in a region of reduced pressure. Although reduced relative to the pressure at the extrusion die, the reduced pressure region may actually be maintained at a pressure above atmospheric pressure, for example up to about 2 atm or even more in some applications, may be maintained at a pressure below atmospheric pressure, for example down to about 0.25 atm or even less in some applications. Further, unless indicated otherwise, all references to pressure provided herein are stated as the absolute pressure.

The solubility of conventional blowing agents, such as chlorofluorocarbons (“CFCs”) and certain alkanes in polystyrene tends to reduce the extrusion melt viscosity and improve cooling of expanded polystyrene melts. For example, the combination of pentane and a CFCs such as Freon 11 and 12 is partially soluble in polystyrene and has been used for generating polystyrene foams that exhibited a generally acceptable appearance and physical properties such as surface finish, cell size and distribution, orientation, shrinkage, insulation property (R-value), and stiffness.

However, in response to the apparent contribution of such CFC compounds to the reduction of the ozone layer in Earth's stratosphere, the widespread use and accompanying atmospheric release of such compounds in applications such as aerosol propellants, refrigerants, foam-blowing agents and specialty solvents has recently been drastically reduced or eliminated by government regulation.

The divergence away from the use of CFCs has led to utilization of alternative blowing agents, such as hydrogen-containing chlorofluoroalkanes (HCFCs). However, while HCFC's are considered to be environmentally friendly blowing agents compared to CFCs, such compounds do still contain some chlorine and are therefore said to have an ozone depletion potential.

Another alternative class of blowing agents, hydrofluorocarbons (HFC's), are now being commonly used as more ozone friendly options. Particularly, CF₃CH₂CF₂H (HFC-245fa), 1,1,1,2-tetrafluoroethane (HFC-134a), 1,1,2,2-tetrafluoroetahne (HFC -134) and 1,1-difluoroethane (HFC-152a), offer desirable improvements, such as zero ozone depletion and lower (but still significant) global warming potential. This class is used as an aid for improved insulation, due at least in part to the low thermal conductivity of the vapor. Hydrocarbons such as pentane, hexane, cyclopentane and other homologs of this series have also been considered.

A new generation of fluororalkene blowing agents has been developed with zero ODP (ozone depletion potential) and low (negligible) GWP (global warming potential) known as hydrofluoroolefins (HFOs) and hydrochlorofluoroolefins (HCFOs). HFOs have been identified as potential low global warming potential blowing agents for the production of thermoplastic foams, such as polystyrene foam, for thermal insulation.

Carbon dioxide is a particularly attractive candidate as a blowing agent, from both an environmental and economic standpoint. Carbon dioxide is inexpensive, and has a low (negligible) global warming potential. The technical challenges that have thus far been associated with successfully using carbon dioxide as a blowing agent however, are, significant in light of the relatively low solubility, high diffusivity, and poor processability of carbon dioxide in polystyrene resins. A further technical challenge is that carbon dioxide does not contribute to thermal insulation performance. Thus, although the thermal conductivity of carbon dioxide is comparable to that of HFC-134a, it has previously been found to rapidly diffuse out of foam, which results in a lowered R-value.

### SUMMARY

Various exemplary embodiments of the present invention are directed to a composition and method for making extruded polymeric foam. The composition and method for making extruded polymeric foam disclosed herein includes carbon dioxide and one or more co-blowing agents to achieve an XPS foam having an improved insulation performance.

In accordance with some exemplary embodiments, a foamable polymeric mixture is disclosed. The foamable polymeric mixture includes a polymer composition, a blowing agent composition comprising carbon dioxide and at least one co-blowing agent, and at least one infrared attenuating agent.

In accordance with some exemplary embodiments, a method of manufacturing extruded polymeric foam is disclosed. The method includes introducing a polymer composition into a screw extruder to form a polymeric melt, injecting a blowing agent composition into the polymeric melt to form a foamable polymeric material, the blowing agent composition comprising carbon dioxide and at least one co-blowing agent, and introducing at least one infrared attenuating agent into the polymeric melt, wherein the extruded polymeric foam exhibits an R-value of at least 5° F.·ft2·hr/BTU per inch.

In accordance with some exemplary embodiments, an extruded polymeric foam is disclosed. The extruded polymeric foam comprises a foamable polymeric material, the material comprising a polymer composition, a blowing agent composition, and nano-graphite, wherein the blowing agent composition comprises carbon dioxide and at least one co-blowing agent selected from hydrofluoroolefins, hydrofluorocarbons, Formacel, and mixtures thereof. The extruded polymeric foam exhibits an R-value of at least 5° F.·ft2·hr/BTU per inch.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic drawing of an exemplary extrusion apparatus useful for practicing methods according to the invention.

FIG. 2 is an aging curve across 180 days of seven exemplary foam samples made in accordance with this invention.

FIG. 3 is an aging curve across 20 days of a comparative foam sample utilizing carbon dioxide as a blowing agent in the absence of any additional co-blowing agents.

### DETAILED DESCRIPTION OF THE DISCLOSURE

A composition and method for making extruded polymeric foam is described in detail herein. The polymeric foam includes carbon dioxide and one or more co-blowing agents to achieve an XPS foam having an improved insulation performance. These and other features of the extruded polymeric foam, as well as some of the many optional variations and additions, are described in detail hereafter.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements. The terms “composition” and “inventive composition” may be used interchangeably herein.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

As used herein, unless specified otherwise, the values of the constituents or components of the blowing agent or other compositions are expressed in weight percent or % by weight of each ingredient in the composition. The values provided include up to and including the endpoints given.

As it pertains to the present disclosure, “closed cell” refers to a polymeric foam having cells, at least 95% of which are closed. However, in the present application, cells may be “open cells” or closed cells (i.e., certain embodiments disclosed herein may exhibit an “open cell” polymeric foam structure).

The general inventive concepts herein relate to a composition and method for making an extruded foam including carbon dioxide as a major blowing agent, together with one or more co-blowing agents to achieve extruded foam having an improved thermal insulation performance. In accordance with some exemplary embodiments, the extruded foam further includes an infrared attenuating agent such as, for example, nano-graphite. In some exemplary embodiments, the one or more co-blowing agents are selected from hydrofluoroolefins, hydrofluorocarbons, Formacel, and mixtures thereof. As discussed in detail hereafter, the carbon dioxide blowing agent together with one or more co-blowing agents makes it possible to achieve an XPS foam having improved thermal insulation performance.

U.S. patent application Ser. No. 14/210,970 discloses an exemplary extrusion process for manufacturing extruded polymeric foam. U.S. patent application Ser. No. 14/210,970 is incorporated herein by reference in its entirety. Extruded polymeric foam in accordance with this present invention may include any combination or sub combination of the features disclosed by the present application and U.S. patent application Ser. No. 14/210,970.

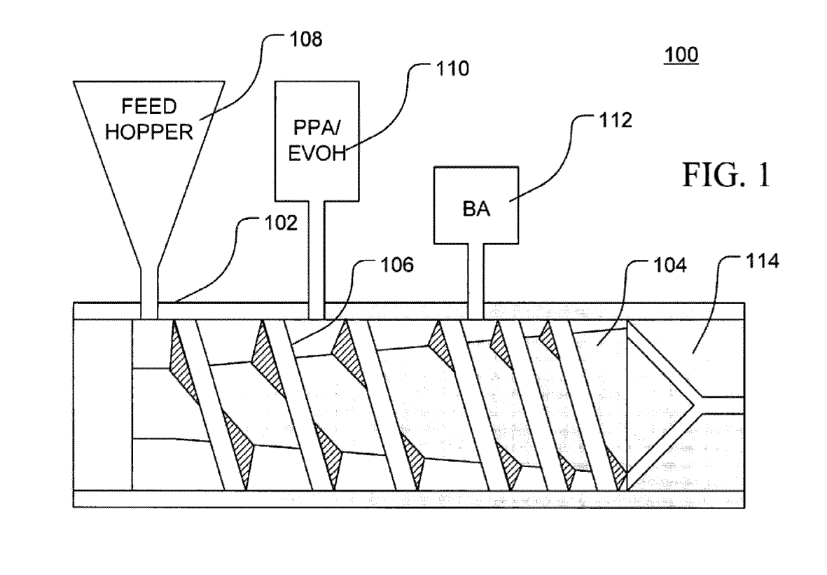

FIG. 1 illustrates a traditional extrusion apparatus 100 useful for practicing methods according to the present invention. The extrusion apparatus 100 may comprise a single or double (not shown) screw extruder including a barrel 102 surrounding a screw 104 on which a spiral flight 106 is provided, configured to compress, and thereby, heat material introduced into the screw extruder. As illustrated in FIG. 1, the polymeric composition may be fed into the screw extruder as a flowable solid, such as beads, granules or pellets, or as a liquid or semi-liquid melt, from one or more (not shown) feed hoppers 108.

As the basic polymeric composition advances through the screw extruder, the decreasing spacing of the flight 106 defines a successively smaller space through which the polymer composition is forced by the rotation of the screw. This decreasing volume acts to increase the temperature of the polymer composition to obtain a polymeric melt (if solid starting material was used) and/or to increase the temperature of the polymeric melt, by increasing shear heating.

As the polymer composition advances through the screw extruder 100, one or more ports may be provided through the barrel 102 with associated apparatus 110 configured for injecting one or more optional processing aids into the polymer composition. Similarly, one or more ports may be provided through the barrel 102 with associated apparatus 112 for injecting one or more blowing agents into the polymer composition. Additional additive, such as infrared attenuating agents, are not injected into the barrel. Rather, the one or more infrared attenuating agents are fed into hopper 108 directly. In some exemplary embodiments, the one or more infrared attenuating agents and/or one or more optional processing aids and blowing agents are introduced through a single apparatus. Once the one or more infrared attenuating agents and/or one or more optional processing aids and blowing agent(s) have been introduced into the polymer composition, the resulting mixture is subjected to some additional blending sufficient to distribute each of the additives generally uniformly throughout the polymer composition to obtain an extrusion composition.

This extrusion composition is then forced through an extrusion die 114 and exits the die into a region of reduced pressure (which may be below atmospheric pressure), thereby allowing the blowing agent to expand and produce a polymeric foam material. This pressure reduction may be obtained gradually as the extruded polymeric mixture advances through successively larger openings provided in the die or through some suitable apparatus (not shown) provided downstream of the extrusion die for controlling to some degree the manner in which the pressure applied to the polymeric mixture is reduced. The polymeric foam may be subjected to additional processing such as calendaring, water immersion, cooling sprays or other operations to control the thickness and other properties of the resulting polymeric foam product.

The foamable polymer composition is the backbone of the formulation and provides strength, flexibility, toughness, and durability to the final product. The foamable polymer composition is not particularly limited, and generally, any polymer capable of being foamed may be used as the foamable polymer in the resin mixture. The foamable polymer composition may be thermoplastic or thermoset. The particular polymer composition may be selected to provide sufficient mechanical strength and/or to the process utilized to form final foamed polymer products. In addition, the foamable polymer composition is preferably chemically stable, that is, generally non-reactive, within the expected temperature range during formation and subsequent use in a polymeric foam.

As used herein, the term “polymer” is generic to the terms “homopolymer,” “copolymer,” “terpolymer,” and combinations of homopolymers, copolymers, and/or terpolymers. Non-limiting examples of suitable foamable polymers include alkenyl aromatic polymers, polyvinyl chloride (“PVC”), chlorinated polyvinyl chloride (“CPVC”), polyethylene, polypropylene, polycarbonates, polyisocyanurates, polyetherimides, polyamides, polyesters, polycarbonates, polymethylmethacrylate, polyphenylene oxide, polyurethanes, phenolics, polyolefins, styrene acrylonitrile (“SAN”), acrylonitrile butadiene styrene, acrylic/styrene/acrylonitrile block terpolymer (“ASA”), polysulfone, polyurethane, polyphenylene sulfide, acetal resins, polyamides, polyaramides, polyimides, polyacrylic acid esters, copolymers of ethylene and propylene, copolymers of styrene and butadiene, copolymers of vinylacetate and ethylene, rubber modified polymers, thermoplastic polymer blends, and combinations thereof.

In one exemplary embodiment, the foamable polymer composition is an alkenyl aromatic polymer material. Suitable alkenyl aromatic polymer materials include alkenyl aromatic homopolymers and copolymers of alkenyl aromatic compounds and copolymerizable ethylenically unsaturated co-monomers. In addition, the alkenyl aromatic polymer material may include minor proportions of non-alkenyl aromatic polymers. The alkenyl aromatic polymer material may be formed of one or more alkenyl aromatic homopolymers, one or more alkenyl aromatic copolymers, a blend of one or more of each of alkenyl aromatic homopolymers and copolymers, or blends thereof with a non-alkenyl aromatic polymer.

Examples of alkenyl aromatic polymers include, but are not limited to, those alkenyl aromatic polymers derived from alkenyl aromatic compounds such as styrene, alpha-methylstyrene, ethylstyrene, vinyl benzene, vinyl toluene, chlorostyrene, and bromostyrene. In at least one embodiment, the alkenyl aromatic polymer is polystyrene.

In certain exemplary embodiments, minor amounts of monoethylenically unsaturated monomers such as C2 to C6 alkyl acids and esters, ionomeric derivatives, and C2 to C6 dienes may be copolymerized with alkenyl aromatic monomers to form the alkenyl aromatic polymer. Non-limiting examples of copolymerizable monomers include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

In certain exemplary embodiments, the foamable polymer melts may be formed substantially of (e.g., greater than 95 percent), and in certain exemplary embodiments, formed entirely of polystyrene. The foamable polymer may be present in the polymeric foam in an amount from about 60% to about 99% by weight, in an amount from about 70% to about 99% by weight, or in an amount from about 85% to about 99% by weight. In certain exemplary embodiments, the foamable polymer may be present in an amount from about 90% to about 99% by weight. As used herein, the terms “% by weight” and “wt %” are used interchangeably and are meant to indicate a percentage based on 100% of the total weight of the dry components.

Exemplary embodiments of the subject invention utilize a blowing agent composition comprising carbon dioxide as a primary blowing agent, along with one or more of a variety of co-blowing agents to achieve the desired polymeric foam properties in the final product. In some exemplary embodiments, the molar percentage of carbon dioxide is 50% or greater with regards to the total blowing agent composition. In some exemplary embodiments, the molar percentage of carbon dioxide is from about 50% to about 70% with regards to the total blowing agent composition, or from about 50% to about 60% with regards to the total blowing agent composition. In some exemplary embodiments, the blowing agent composition includes carbon dioxide in a weight percentage from about 30 to about 70% by weight of the total blowing agent composition. In some exemplary embodiments, the blowing agent composition includes carbon dioxide from about 30 to about 60% by weight of the total blowing agent composition. In some exemplary embodiments, the blowing agent composition includes carbon dioxide from about 30 to about 50% by weight of the total blowing agent composition.

According to one aspect of the present invention, the one or more co-blowing agents are selected based on the considerations of low GWP, low thermal conductivity, non-flammability, high solubility in polystyrene, high blowing power, low cost, and the overall safety of the co-blowing agent. In some exemplary embodiments, the one or more co-blowing agents of the blowing agent composition may comprise one or more halogenated blowing agents, such as hydrofluorocarbons (HFCs), hydrochlorofluorocarbons, hydrofluoroethers, hydrofluoroolefins (HFOs), hydrochlorofluoroolefins (HCFOs), hydrobromofluoroolefins, hydrofluoroketones, hydrochloroolefins, and fluoroiodocarbons, alkyl esters, such as methyl formate, water, and mixtures thereof. In other exemplary embodiments, the co-blowing agent comprises one or more HFOs, HFCs, Formacel, and mixtures thereof.

The hydrofluoroolefin co-blowing agents may include, for example, 3,3,3-trifluoropropene (HFO-1243zf); 2,3,3-trifluoropropene; (cis and/or trans)-1,3,3,3-tetrafluoropropene (HFO-1234ze), particularly the trans isomer; 1,1,3,3-tetrafluoropropene; 2,3,3,3-tetrafluoropropene (HFO-1234yf); (cis and/or trans)-1,2,3,3,3-pentafluoropropene (HFO-1225ye); 1,1,3,3,3-pentafluoropropene (HFO-1225zc); 1,1,2,3,3-pentafluoropropene (HFO-1225yc); hexafluoropropene (HFO -1216); 2-fluoropropene, 1 -fluoropropene; 1,1-difluoropropene; 3,3 -di fluoropropene; 4,4,4-trifluoro-1-butene; 2,4,4,4-tetrafluorobutene-1; 3,4,4,4-tetrafluoro-1-butene; octafluoro-2-pentene (HFO-1438); 1,1,3,3,3-pentafluoro-2-methyl-1-propene; octafluoro-1-butene; 2,3,3,4,4,4-hexafluoro-1-butene; 1,1,1,4,4,4-hexafluoro-2-butene (HFO1336mzz) or (HFO-1336mzz-Z); 1,2-difluoroethene (HFO-1132); 1,1,1,2,4,4,4-heptafluoro-2-butene; 3-fluoropropene, 2,3-difluoropropene; 1,1,3-trifluoropropene; 1,3,3-trifluoropropene; 1,1,2-trifluoropropene; 1-fluorobutene; 2-fluorobutene; 2-fluoro-2-butene; 1,1-difluoro-1-butene; 3,3-difluoro-1-butene; 3,4,4-trifluoro-1-butene; 2,3,3-trifluoro-1-butene; 1,1,3,3-tetrafluoro-1-butene; 1,4,4,4-tetrafluoro-1-butene; 3,3,4,4-tetrafluoro-1-butene; 4,4-difluoro-1-butene; I, I, 1-trifluoro-2-butene; 2,4,4,4-tetrafluoro-1-butene; 1,1,1,2-tetrafluoro-2butene; 1,1,4,4,4-pentafluorol-butene; 2,3,3,4,4-pentafluoro-1-butene; 1,2,3,3,4,4,4-heptafluoro-1-butene; 1,1,2,3,4,4,4-heptafluoro-1-butene; and 1,3,3,3-tetrafluoro-2-(trifluoromethyl)-propene. In some exemplary embodiments, the co-blowing agent includes HFO-1234ze.

The co-blowing agent may also include HCFO-1233. The term “HCFO-1233” is used herein to refer to all trifluoromonochloropropenes. Among the trifluoromonochloropropenes are included both cis- and trans-1,1,1-trifluo-3,chlororopropene (HCFO-1233zd or 1233zd). The term “HCFO-1233zd” or “1233zd” is used herein generically to refer to 1,1,1-trifluo-3,chloro-propene, independent of whether it is the cis- or trans-form. The terms “cis HCFO-1233zd” and “trans HCFO-1233zd” are used herein to describe the cis- and trans-forms of 1,1,1-trifluo,3-chlororopropene, respectively. The term “HCFO-1233zd” therefore includes within its scope cis HCFO-1233zd (also referred to as 1233zd(Z)), trans HCFO-1233zd (also referred to as 1233(E)), and all combinations and mixtures of these.

In some exemplary embodiments, the co-blowing agent may comprise one or more hydrofluorocarbons. The specific hydrofluorocarbon utilized is not particularly limited. A non-exhaustive list of examples of suitable blowing HFC blowing agents include 1,1-difluoroethane (HFC-152a), 1,1,1,2-tetrafluoroethane (HFC-134a), 1,1,2,2-tetrafluoroethane (HFC-134), 1,1,1-trifluoroethane (HFC-143a), difluoromethane (HFC-32), 1,3,3,3-pentafluoropropane (HFO-1234ze), pentafluoro-ethane (HFC-125), fluoroethane (HFC-161), 1,1,2,2,3,3-hexafluoropropane (HFC 236ca), 1,1,1,2,3,3-hexafluoropropane (HFC-236ea), 1,1,1,3,3,3-hexafluoropropane (HFC-236fa), 1,1,1,2,2,3-hexafluoropropane (HFC-245ca), 1,1,2,3,3-pentafluoropropane (HFC-245ea), 1,1,1,2,3 pentafluoropropane (HFC-245eb), 1,1,1,3,3-pentafluoropropane (HFC-245fa), 1,1,1,4,4,4-hexafluorobutane (HFC-356mff), 1,1,1,3,3-pentafluorobutane (HFC-365mfc), and combinations thereof.

In some exemplary embodiments, the co-blowing agent may comprise the DuPont™ product Formacel® FEA-1100. A non-exhaustive list of potential embodiments of Formacel include FEA-1100, HFO-1336mzz, Formacel-1100, and 1,1,1,4,4,4-hexafluoro-2-butene. Formacel is an attractive co-blowing agent because it has a low global warming potential (“GWP”) of 9.6 and is non-flammable. Further, the low thermal conductivity (10.7 mW/m·k) of Formacel may boost the R-value of the XPS foam as disclosed herein.

In some exemplary embodiments, the at least one co-blowing agent is selected from hydrofluoroolefins, hydrofluorocarbons, Formacel, and mixtures thereof. In some exemplary embodiments, the blowing agent composition comprises carbon dioxide and the co-blowing agent HFC-134a. In some exemplary embodiments, the blowing agent composition comprises carbon dioxide and HFO-1234ze. In some exemplary embodiments, the blowing agent composition comprises carbon dioxide and FEA-1100. The co-blowing agents identified herein may be used singly or in combination. In some exemplary embodiments, the blowing agent composition comprises greater than 50 molar percent carbon dioxide and less that 50 molar percent of one or more co-blowing agents.

In some exemplary embodiments, the total blowing agent composition including carbon dioxide and one or more co-blowing agents is present in an amount from about 2% to about 12% by weight, and in exemplary embodiments, from about 4% to about 11% by weight, or from about 6% to about 10% by weight (based upon the total weight of the polymeric foam).

The carbon dioxide blowing agent and one or more co-blowing agents may be introduced in liquid or gaseous form (e.g., a physical blowing agent) or may be generated in situ while producing the foam (e.g., a chemical blowing agent). For instance, the blowing agent may be formed by decomposition of another constituent during production of the foamed thermoplastic. For example, a carbonate composition, polycarbonic acid, sodium bicarbonate, or azodicarbonamide and others that decompose and/or degrade to form N₂, CO₂, and H₂O upon heating may be added to the foamable resin and carbon dioxide will be generated upon heating during the extrusion process.

In addition to the blowing agents, one or more non-VOC processing aids may be added to the polymeric melt to expand the processing windows in XPS extrusion. U.S. patent application Ser. No. 14/210,970 cited above discloses processing aids for use in manufacturing extruded polystyrene foams. U.S. patent application Ser. No. 14/210,970 is incorporated herein by reference in its entirety.

The foamable composition may further contain at least one infrared attenuating agent (IAA) to increase the R-value of the foam product. The use of infrared attenuating agents is disclosed in U.S. Pat. No. 7,605,188. U.S. Pat. No. 7,605,188 is incorporated herein by reference in its entirety. Environmentally friendly blowing agents tend to decrease the R-value of the foam product compared to a conventional HCFC foamed product. The addition of low levels of an infrared attenuating agent to a foamable composition containing the blowing agent compositions disclosed herein may increase the R-value of the foam to an amount at least comparable to, or better than, foam produced with an HCFC blowing agent. In some exemplary embodiments, the infrared attenuating agent may be present in an amount less than or equal to about 1% by weight. In some exemplary embodiments, the infrared attenuating agent may be present in an amount from 0 to about 10% by weight, from 0 to about 3% by weight, from 0 to about 2% by weight, or from 0 to about 1% by weight.

Non-limiting examples of suitable IAAs for use in the present composition include nano-graphite, graphene, graphite, carbon black, powdered amorphous carbon, asphalt, granulated asphalt, milled glass, fiber glass strands, mica, black iron oxide, boron nitrite, metal flakes or powder (for example, aluminum flakes or powder), carbon nanotube, nanographene platelets, carbon nanofiber, activated carbon, titanium dioxide, and combinations thereof.

In some exemplary embodiments, the IAA is graphite, graphene, nano-graphite. In at least one exemplary embodiment, the IAA is nano-graphite. The nano-graphite can be multilayered by furnace high temperature expansion from acid-treated natural graphite or microwave heating expansion from moisture saturated natural graphite. In addition, the nano-graphite may be multi-layered nano-graphite which has at least one dimension less than 100 nm. In some exemplary embodiments, the nano-graphite has at least two dimensions less than 100 nm.

The nano-graphite may or may not be chemically or surface modified and may be compounded in a polyethylene methyl acrylate copolymer (EMA), which is used both as a medium and a carrier for the nano-graphite. Other possible carriers for the nano-graphite include polymer carriers such as, but not limited to, other acrylates such as propyl methyl acrylate, butyl metal acrylate, polymethyl methacrylate (PMMA), polystyrene, styrene-acrylonitrile (SAN) copolymer, polyvinyl alcohol (PVOH), and polyvinyl acetate (PVA). In exemplary embodiments, the nano-graphite is substantially evenly distributed throughout the foam. As used herein, the phrase “substantially evenly distributed” is meant to indicate that the substance (for example, nano-graphite) is evenly distributed or nearly evenly distributed within the foam matrix.

In some exemplary embodiments of the present invention, an extruded polymeric foam having a density of about 2 pcf includes a blowing agent composition comprising about 2.2% carbon dioxide, about 3% HFC-134a, and about 1% nano-graphite or alternatively about 2.2% carbon dioxide, about 3.5% HFC-134a, and about 1% nano-graphite, wherein each % is a weight percentage relative to the total solids. In some exemplary embodiments, an extruded polymeric foam having a density of about 2 pcf includes a blowing agent composition comprising about 2.2% carbon dioxide, about 3.5% HFO-1234ze, and about 1% nano-graphite or alternatively about 2% carbon dioxide, about 4% HFO-1234ze, and about 1% nano-graphite, wherein each % is a weight percentage relative to the total solids. In some exemplary embodiments, an extruded polymeric foam having a density of about 2 pcf includes a blowing agent composition comprising about 2.75% carbon dioxide, about 5% FEA-1100, and about 0% nano-graphite or alternatively about 2.75% carbon dioxide, about 5% FEA-1100, and about 1% nano-graphite or alternatively about 2.75% carbon dioxide, about 6% FEA-1100, and about 1% nano-graphite, wherein each % is a weight percentage relative to the total solids.

The foam composition may further contain a fire retarding agent in an amount up to 5% or more by weight. For example, fire retardant chemicals may be added in the extruded foam manufacturing process to impart fire retardant characteristics to the extruded foam products. Non-limiting examples of suitable fire retardant chemicals for use in the inventive composition include brominated aliphatic compounds such as hexabromocyclododecane (HBCD) and pentabromocyclohexane, brominated phenyl ethers, esters of tetrabromophthalic acid, halogenated polymeric flame retardant such as brominated polymeric flame retardant, phosphoric compounds, and combinations thereof.

Optional additives such as nucleating agents, plasticizing agents, pigments, elastomers, extrusion aids, antioxidants, fillers, antistatic agents, biocides, termite-ocide; colorants; oils; waxes; flame retardant synergists; and/or UV absorbers may be incorporated into the inventive composition. These optional additives may be included in amounts necessary to obtain desired characteristics of the foamable gel or resultant extruded foam products. The additives may be added to the polymer mixture or they may be incorporated in the polymer mixture before, during, or after the polymerization process used to make the polymer.

Once the polymer processing aid(s), blowing agent(s), and optional additional additives have been introduced into the polymeric material, the resulting mixture is subjected to some additional blending sufficient to distribute each of the additives generally uniformly throughout the polymer composition to obtain an extrusion composition.

In some exemplary embodiments, the foam composition produces rigid, substantially closed cell, polymer foam boards prepared by an extruding process. Extruded foams have a cellular structure with cells defined by cell membranes and struts. Struts are formed at the intersection of the cell membranes, with the cell membranes covering interconnecting cellular windows between the struts. In some exemplary embodiments, the foams have an average density of less than 10 pcf, or less than 5 pcf, or less than 3 pcf. In some exemplary embodiments, the extruded polystyrene foam has a density from about 1.3 pcf to about 4.5 pcf. In some exemplary embodiments, the extruded polystyrene foam has a density of about 2 pcf. In some exemplary embodiments, the extruded polystyrene foam has a density of about 1.5 pcf, or lower than 1.5 pcf.

It is to be appreciated that the phrase “substantially closed cell” is meant to indicate that the foam contains all closed cells or nearly all of the cells in the cellular structure are closed. In most exemplary embodiments, not more than 30% of the cells are open cells, and particularly, not more than 10%, or more than 5% are open cells, or otherwise “non-closed” cells. In some exemplary embodiments, from about 1.10% to about 2.85% of the cells are open cells. The closed cell structure helps to increase the R-value of a formed, foamed insulation product. It is to be appreciated, however, that it is within the purview of the present invention to produce an open cell structure, although such an open cell structure is not an exemplary embodiment.

Additionally, the inventive foam composition produces extruded foams that have insulation values (R-values) per inch of about 4 to about 7. In at least one embodiment, the R-value is about 5 per inch. In addition, the average cell size of the inventive foam and foamed products may be from about 0.005 mm (5 microns) to 0.6 mm (600 microns), in some exemplary embodiments from 0.05 mm (50 microns) to 0.200 mm (200 microns), and in some exemplary embodiments from 0.09 mm (90 microns) to 0.11 mm (110 microns). The extruded inventive foam may be formed into an insulation product such as a rigid insulation board, insulation foam, packaging product, and building insulation or underground insulation (for example, highway, airport runway, railway, and underground utility insulation).

The inventive foamable composition additionally may produce extruded foams that have a high compressive strength, which defines the capacity of a foam material to withstand axially directed pushing forces. In at least one exemplary embodiment, the inventive foam compositions have a compressive strength within the desired range for extruded foams, which is between about 6 and 120 psi. In some exemplary embodiments, the inventive foamable composition produces foam having a compressive strength between about 37 and about 56 psi at a density of about 2 pcf after 30 days aging.

In accordance with another exemplary aspect, the extruded inventive foams possess a high level of dimensional stability. For example, the change in dimension in any direction is 5% or less. In addition, the foam formed by the inventive composition is desirably monomodal and the cells have a relatively uniform average cell size. As used herein, the average cell size is an average of the cell sizes as determined in the X, Y and Z directions. In particular, the “X” direction is the direction of extrusion, the “Y” direction is the cross machine direction, and the “Z” direction is the thickness. In the present invention, the highest impact in cell enlargement is in the X and Y directions, which is desirable from an orientation and R-value perspective. In addition, further process modifications would permit increasing the Z-orientation to improve mechanical properties while still achieving an acceptable thermal property. The extruded inventive foam can be used to make insulation products such as rigid insulation boards, insulation foam, and packaging products.

As previously disclosed in detail herein, a blowing agent composition comprising carbon dioxide as a primary blowing agent together with one or more co-blowing agents may be used in combination with an infrared attenuating agent such as nano-graphite to achieve an XPS foam having an R-value of about 5. The carbon dioxide blowing agent provides a blowing power suitable to attain a desired XPS foam density, and the one or more co-blowing agents optionally in combination with the attenuating agent provide the desired R-value.

The inventive concepts have been described above both generically and with regard to various exemplary embodiments. Although the general inventive concepts have been set forth in what is believed to be exemplary illustrative embodiments, a wide variety of alternatives known to those of skill in the art can be selected within the generic disclosure. Additionally, following examples are meant to better illustrate the present invention, but do in no way limit the general inventive concepts of the present invention.

### EXAMPLES

A variety of extruded polystyrene (“XPS”) foams were prepared using a twin screw extruder. Polystyrene was melted in the extruder and then mixed with an injected with various blowing agent compositions to form homogeneous solutions. The blowing agent compositions comprised various amounts of carbon dioxide and one or more co-blowing agents as set forth below. The solutions were then cooled to the desired foaming conditions, including a die temperature between 110 and 130° C. and foaming die pressure between 800 and 1200 psi. Table 1 lists the physical properties of various co-blowing agents that were evaluated with regards to their use in combination with carbon dioxide.

TABLE 1
Physical Properties of Co-Blowing Agents

| | Chemical | | Flam- | | | BP | λ |
|---|---|---|---|---|---|---|---|
| BAs | Structure | GWP | mability | MW | % F | (° C.) | (mW/m · k) |
| 134a | CH2FCF3 | 1430 | No | 102 | 74.5 | −29 | 13 (14.6) |
| 152a | CHF2CH3 | 124 | Yes | 66 | 57.6 | −24.2 | 14.7 |
| HFO-1234ze | trans- | 6 | No | 114 | 66.7 | −19 | 13 |
| | CHF═CHCF3 | | | | | | |
| HFO-1233zd | CF3CH═CHCl | 7 | No | 130.5 | 43.7 | 19.5 | 10.2 |
| FEA-1100 | CF3CH═CHCF3 | 9.4 | No | 164 | 69.5 | 33 | 10.7 |

Table 2 below lists the amount of carbon dioxide/co-blowing agent/attenuating agent used to form seven exemplary XPS foams. As shown in the table, carbon dioxide comprised 59 molar percent or greater of the blowing agent composition for each of the seven exemplary foams.

TABLE 2
Blowing Agent Compositions

| | | | | Molar |
|---|---|---|---|---|
| Formulas | BAs | wt % | MW | Percentage |
| CO2/HFC-134a/graphite | CO2 | 2.2 | 44 | 63.0 |
| (2.2/3/1) | HFC-134a | 3 | 102 | 37.0 |
| CO2/HFC-134a/graphite | CO2 | 2.2 | 44 | 59.3 |
| (2.2/3.5/1) | HFC-134a | 3.5 | 102 | 40.7 |
| CO2/HFO-1234ze/graphite | CO2 | 2.2 | 44 | 62.0 |
| (2.2/3.5/1) | HFO-1234ze | 3.5 | 114 | 38.0 |
| CO2/HFO-1234ze/graphite | CO2 | 2.2 | 44 | 58.8 |
| (2.2/4/1) | HFO-1234ze | 4 | 114 | 41.2 |
| CO2/FEA-1100/graphite | CO2 | 2.75 | 44 | 67.2 |
| (2.75/5/0) | FEA-1100 | 5 | 164 | 32.8 |
| CO2/FEA-1100/graphite | CO2 | 2.75 | 44 | 67.2 |
| (2.75/5/1) | FEA-1100 | 5 | 164 | 32.8 |
| CO2/FEA-1100/graphite | CO2 | 2.75 | 44 | 63.1 |
| (2.75/6/1) | FEA-1100 | 6 | 164 | 36.9 |

Table 3 below summarizes various properties of the seven foam samples including density, cell size, open cell content, and compressive strength. The values for Table 3 were measured based on foam boards with a thickness of 1 inch and a width of 20 inches made from each of the seven exemplary foam compositions.

TABLE 3
Physical Properties of XPS Foam Based on
Variations in Blowing Agent Compositions

| | Density | Cell Size | Open | Compressive |
|---|---|---|---|---|
| Formulas | (pcf) | (mm) | cell (%) | strength (psi) |
| CO2/HFC-134a/graphite | 2.08 | 0.10 | 2.85 | 38.0 |
| (2.2/3/1) | | | | |
| CO2/HFC-134a/graphite | 2.14 | 0.10 | 2.40 | 39.3 |
| (2.2/3.5/1) | | | | |
| CO2/HFO-1234ze/graphite | 2.15 | 0.10 | 1.10 | 55.5 |
| (2.2/3.5/1) | | | | |
| CO2/HFO-1234ze/graphite | 2.33 | 0.10 | 1.57 | 51.3 |
| (2.2/4/1) | | | | |
| CO2/FEA-1100/graphite | 2.13 | 0.11 | 1.82 | 46.5 |
| (2.75/5/0) | | | | |
| CO2/FEA-1100/graphite | 2.05 | 0.09 | 1.75 | 36.7 |
| (2.75/5/1) | | | | |
| CO2/FEA-1100/graphite | 2.01 | 0.09 | 2.39 | 42.6 |
| (2.75/6/1) | | | | |

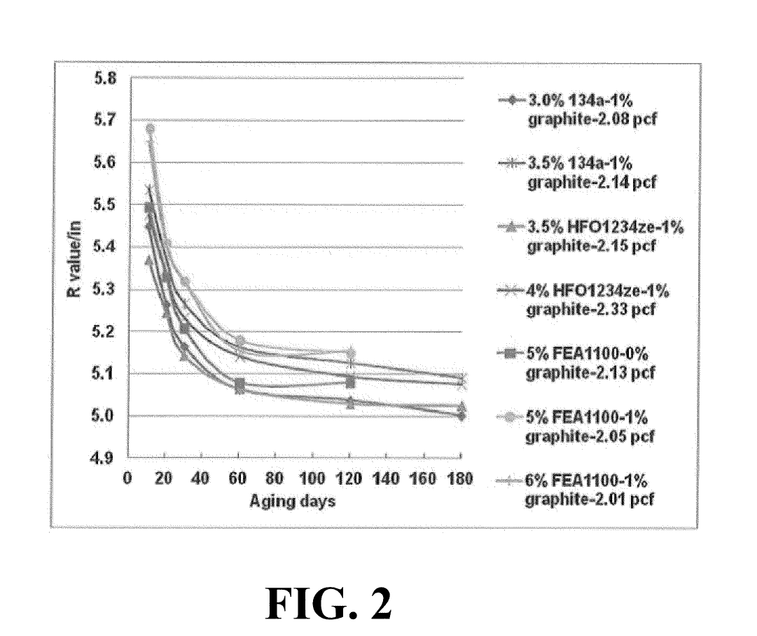

The R-value was measured for XPS foams made using each of the seven blowing agent compositions. FIG. 2 below shows the aging curves of each sample across 180 days. It can be observed that the R-value of each foam sample varies depending on the co-blowing agent and attenuating agent included in the composition. Particularly, an increased amount of co-blowing agent together with the addition of nano-graphite improves the thermal performance of each sample. As shown in FIG. 2, each of the seven samples leveled off above an R-value per inch of 5 after 60 days.

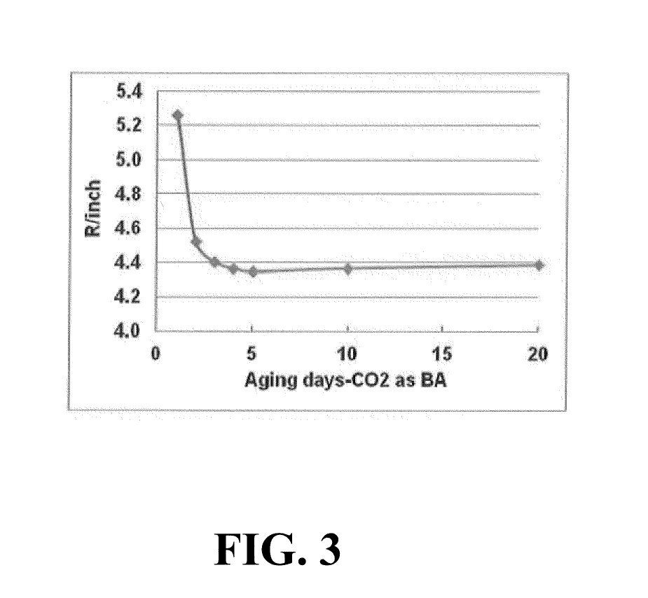

For comparative purposes, an XPS foam was made utilizing carbon dioxide as the sole blowing agent, without the use of a co-blowing agent. The comparative foam further included phase changing material (PT24 from Entropy Solutions) as a processing aid and plasticizer, along with nano-graphite as an infrared attenuating agent. The comparative XPS foam board had a density of 1.9 pcf, with a thickness of 1 inch and a width of 23 inches. As shown in FIG. 3 below, the R-value after the first day of aging reached a value 5.3; however, the R-value dropped drastically within the first 5 days. The comparative foam board eventually leveled off at an R-value of approximately 4.4.

Thus, the exemplary XPS foam boards utilizing a blowing agent composition comprising carbon dioxide and one or more co-blowing agents show that each of the co-blowing agents, particularly FEA-1100, provide a nearly constant R value independent of aging time after 60 days. This is particularly true for foams including an infrared attenuating agent. These results may indicate that FEA-1100 has a very slow diffusion rate out of XPS foam. This effect is beneficial to the thermal performance of the XPS foam, particularly across an extended period of time.

As used in the description of the invention and the appended claims, the singular forms “a,” “an,” and “the” are intended to include the plural forms as well, unless the context clearly indicates otherwise. To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Unless otherwise indicated herein, all sub-embodiments and optional embodiments are respective sub-embodiments and optional embodiments to all embodiments described herein. While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative process, and illustrative examples shown and described. Accordingly, departures may be made from such details without departing from the spirit or scope of the applicant's general disclosure herein.

What is claimed is:

1. A foamable polymeric mixture comprising:
a polymer composition;
a blowing agent composition, the blowing agent composition comprising carbon dioxide and at least one co-blowing agent; and
at least one infrared attenuating agent.

2. The foamable polymeric mixture of claim 1, wherein the blowing agent composition comprises at least 50 molar percent carbon dioxide.

3. The foamable polymeric mixture of claim 1, wherein the at least one co-blowing agent is selected from hydrofluoroolefins, hydrofluorocarbons, Formacel FEA-110, and mixtures thereof.

4. The foamable polymeric mixture of claim 3, wherein the at least one co-blowing agent is selected from HFC-134a, HFC-134, HFC-152a, HFO-1234ze, HFO-1233zd, and FEA-1100.

5. The foamable polymeric mixture of claim 4, wherein the at least one co-blowing agent is selected from HFC-134a, HFO-1234ze, HFO-1243zf, and FEA-1100.

6. The foamable polymeric mixture of claim 1, wherein the at least one infrared attenuating agent comprises from about 0% to about 1% by weight of the total solids.

7. The foamable polymeric mixture of claim 1, wherein the at least one infrared attenuating agent comprises nano-graphite.

8. The foamable polymer mixture of claim 1, wherein the polymer composition comprises polystyrene.

9. The foamable polymer mixture of claim 1, wherein the blowing agent composition comprises at least 50 molar percent carbon dioxide and less than 50 molar percent FEA-1100.

10. A method of manufacturing extruded polymeric foam comprising:
introducing a polymer composition into a screw extruder to form a polymeric melt;
injecting a blowing agent composition into the polymeric melt to form a foamable polymeric material, the blowing agent composition comprising carbon dioxide and at least one co-blowing agent; and
introducing at least one infrared attenuating agent into the polymeric melt,
wherein the extruded polymeric foam exhibits an R-value of at least 5° F.·ft2·hr/BTU per inch.

11. The method of claim 10, wherein the blowing agent composition comprises at least 50 molar percent carbon dioxide.

12. The method of claim 10, wherein the at least one co-blowing agent is selected from HFC-134a, HFC-152a, HFO-1234ze, HFO-1233zd, and FEA-1100.

13. The method of claim 10, wherein the at least one infrared attenuating agent comprises from about 0% to about 1% by weight of the total solids.

14. The method of claim 10, wherein the at least one infrared attenuating agent comprises nano-graphite.

15. The method of claim 10, wherein the polymeric foam is a substantially closed cell foam.

16. The method of claim 10, wherein the blowing agent composition comprises at least 50 molar percent carbon dioxide and less than 50 molar percent FEA-1100.

17. An extruded polymeric foam comprising:
a foamable polymeric material, the material comprising:
a polymer composition;
a blowing agent composition, the blowing agent composition comprising carbon dioxide and at least one co-blowing agent selected from hydrofluoroolefins, hydrofluorocarbons, Formacel, and mixtures thereof; and
nano-graphite,
wherein the extruded polymeric foam exhibits an R-value of at least 5° F.·ft2·hr/BTU per inch.

18. The extruded polymeric foam of claim 17, wherein the polymer composition comprises polystyrene.
